(19) United States
(12) Patent Application Publication
(10) Pub. No.: US 2022/0043279 A1
(43) Pub. Date: Feb. 10, 2022

(54) TYPE OF GLASSES WITH FLEXIBLE NOSE PADS

(71) Applicant: Zhan Shi (Xiamen) Optical Co., Ltd, Xiamen City (CN)

(72) Inventor: Shixian LIN, Xiamen City (CN)

(21) Appl. No.: 16/987,905

(22) Filed: Aug. 7, 2020

(51) Int. Cl. G02C 5/04; G02C 5/08

(52) U.S. Cl. CPC G02C 5/04; G02C 5/006; G02C 5/08

(57) ABSTRACT

The utility model provides a type of glasses with flexible nose pads, which can be applied to a variety of glasses structures. The glasses comprise a left lens assembly and a right lens assembly arranged symmetrically and connected by a top bar. The glasses also contain flexible nose pads, one end of which is arranged on the left lens assembly and the other end of which is arranged on the right lens assembly. The elastic middle part of the flexible nose pad is adapted to the shape of the nose bridge. The flexible nose pad may be adjusted at will according to the shape of nose bridge of different people, suitable for most people. During a process of folding, even if the folded temples are pressed against the flexible nose pads, the flexible nose pads would not deform. Moreover, when the temples are no longer pressed onto the flexible nose pads, they would be directly restored to their original shape, making the folding process smoother. When the folded glasses need to be put into a storage box, there is no need to worry about the flexible nose pads being compressed. As a result, the internal space of the storage box is reduced, making it easy to carry.

### FIELD OF THE INVENTION

The utility model relates to the technical field of glasses, in particular to a type of glasses using flexible nose pads.

### BACKGROUND OF THE INVENTION

When purchasing glasses, most consumers would choose glasses of a right size and a favorite style according to their own tastes. However, since most of the nose pads on the existing glasses adopt a hard structure, when the shape of nose bridges of different people is inconsistent, it is necessary to adjust the spacing between the nose pads, or to make a selection on purchase. These factors have greatly restricted consumers when purchasing glasses. Furthermore, during a folding process of the existing foldable glasses, the folding of temples would cause interference to nose pads, making the folding process inconvenient, and leading to deformation of the nose pads over time.

In view of this, the inventor specially designs a type of glasses with flexible nose pads.

### Content of Utility Model

In order to solve the above problems, the technical scheme of the present utility model is as follows:

The utility model provides a type of glasses with flexible nose pads, which can be applied to a variety of glasses structures. The glasses comprise a left lens assembly and a right lens assembly arranged symmetrically and connected by a top bar. The glasses also contain flexible nose pads, one end of which is arranged on the left lens assembly and the other end of which is arranged on the right lens assembly. The elastic middle part of the flexible nose pad is adapted to the shape of the nose bridge.

Further, the flexible nose pads are integrally formed.

Further, the flexible nose pads include a left connecting piece connected with the left lens assembly, a right connecting piece connected with the right lens assembly, and a flexible structure located between the left connecting piece and the right connecting piece.

Further, the flexible structure includes a flexible arc part at the front end of the human nose bridge and a flexible straight part at both ends of the human nose bridge.

Further, the left connecting piece and the right connecting piece are respectively connected to the left lens assembly and the right lens assembly.

Further, the left connecting piece and the right connecting piece are respectively connected to both ends of the top bar.

Further, the left lens assembly and the right lens assembly have the same structure, and both comprising lenses and temples.

Further, a type of glasses provided with flexible nose pads according to Claim 7, wherein the top bar between the two lenses adopts the first folding structure or a conventional connecting structure.

Further, the middle part of the temples adopts the second folding structure or a conventional integrated structure.

Further, both the left lens assembly and the right lens assembly further comprise frames.

Compared with the existing glasses, the glasses proposed in the present utility model have the following advantages by setting flexible nose pads between the left lens assembly and the right lens assembly:

First, the flexible nose pads may be adjusted at will according to the shape of nose bridges of different people, suitable for most people;

Second, during a process of folding, even if the folded temples are pressed against the flexible nose pads, the flexible nose pads would not deform. Moreover, when the temples are no longer pressed onto the flexible nose pads, they would be directly restored to their original shape, making the folding process smoother.

Third, when the folded glasses need to be put into a storage box, there is no need to worry about the flexible nose pads being compressed. As a result, the internal space of the storage box is reduced, making it easy to carry.

### BRIEF INTRODUCTION OF DRAWINGS

The drawings described herein are used to provide a further understanding of the utility model, and constitute a part of the utility model. The illustrative embodiments of the utility model as well as the description thereof are used to interpret the utility model, and do not constitute an improper limitation on the utility model.

Wherein

FIG. 1 is a schematic diagram of the structure of flexible nose pads of the present utility model;

FIG. 2 is a rear view of flexible nose pads of the present utility model;

FIG. 3 is a side view of flexible nose pads of the present utility model;

FIG. 4 is a schematic diagram for the installation of flexible nose pads of the present utility model.

### LABEL DESCRIPTION

10—flexible nose pad, 11—left connecting piece, 12—right connecting piece, 13—flexible structure, 131—flexible arc part, 132—flexible straight part, 20—left lens assembly, 21—lens, 22—temples, 30—right lens assembly, 40—connecting top bar

### DETAILED DESCRIPTION OF THE PREFERRED EMBODIMENTS

In order to make the technical problems, technical solutions and beneficial effects to be solved by the present utility model clearer and clearer, the present utility model will be further described in detail below in conjunction with the drawings and embodiments. It shall be understood that the specific embodiments described herein are only used to interpret the present utility model, and are not used to limit the present utility model.

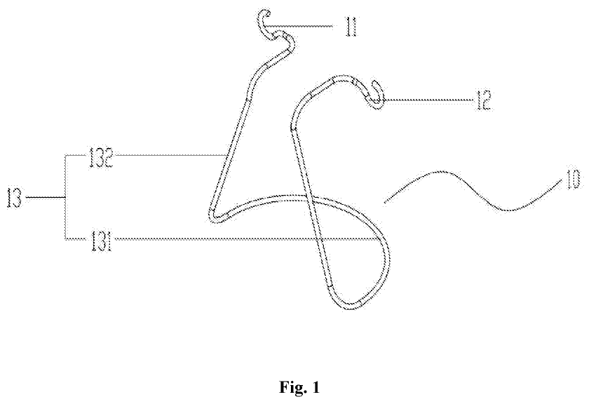

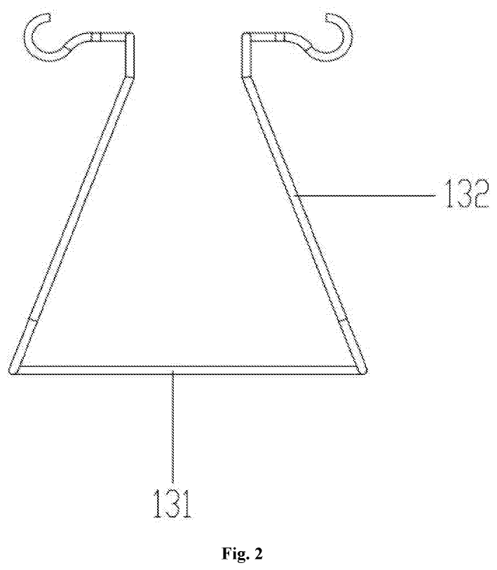

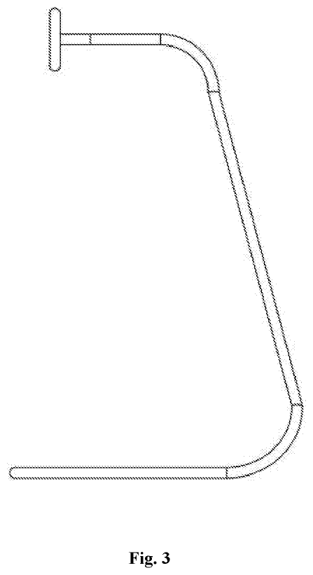

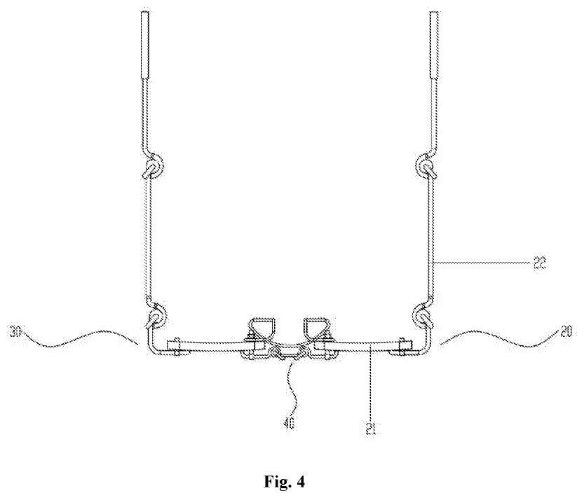

With reference to FIG. 1-4, the utility model provides a type of glasses with flexible nose pads, which can be applied to a variety of glasses structures. The glasses comprise a left lens assembly 20 and a right lens assembly 30 arranged symmetrically and connected by a top bar 40. 30 The glasses also contain flexible nose pads 10, one end of which is arranged on the left lens assembly 20 and the other end of which is arranged on the right lens assembly 30. The elastic middle part of the flexible nose pad 10 is adapted to the shape of the nose bridge. The above-mentioned left lens assembly 20, right lens assembly 30, and connecting top bar 40 are not limited to the structures shown in the drawings, and the structures in the drawings are only for illustrative purposes.

The said flexible nose pads 10 are integrally formed by a material with good elasticity, such as a medical wire. Specifically, the said flexible nose pads 10 comprise a left connecting piece 11 connected to the left lens assembly 20, a right connecting piece 12 connected to the right lens assembly 30, and a flexible structure 13 located between the left connecting piece 11 and the right connecting piece 12. The said flexible structure 13 comprises a flexible arc part 131 at the front end of human nose bridge and a flexible straight part 132 at both ends of human nose bridge. The flexible straight parts 132 at both ends are inclined inward. When used by a person with a large nose bridge, the flexible straight parts 132 at both ends will be slightly stretched. However, the flexible arc part 131 can still be supported on the front end of human nose bridge without sliding down.

The structure of the left lens 21 assembly 20 and the right lens assembly 30 of the present utility model is not limited to this embodiment, for example:

I The left lens 21 assembly 20 and the right lens assembly 30 only comprise the structure of the lens 21 and the temple 22;

II Or they may also comprise the structure of the lens 21, the temple 22 and the frame;

III Or the temple 22 is a plastic structure, and the frames for the left lens assembly 20 and the right lens assembly 30 are of an integrally-formed plastic structure.

Corresponding to the above-mentioned structures, the left connecting assembly and the right connecting assembly of the present utility model are not limited to the arc hook-shaped structure shown in the figure. For the above-mentioned structures, the specific connection methods are as follows:

For the first type, the said left connecting piece 11 and the right connecting piece 12 are both locked to the rear side of the left lens 21 assembly 20 and the right lens assembly 30 via nuts (because there is no frame, it can only be locked onto the lens 21). Bolts are disposed on the left lens 21 assembly 20 and the right lens assembly 30. At the same time, spacers are disposed between the left connecting piece 11 and the nut, and between the right connecting piece 12 and the nut. The left connecting piece 11 and the right connecting piece 12 assume a circular arc hook shape, and directly catch the bolts. Then washers are pressed in, and locking is achieved to fix the flexible nose pad 10 with nuts and bolts.

For the second type, since the structure has a frame, the left connecting piece 11 and the right connecting piece 12 may be directly welded to the inner edges of frames of the left lens 21 assembly 20 and the right lens assembly 30, respectively. At this time, the shapes of the left connecting piece 11 and the right connecting piece 12 are adapted to the shape of the lens frame, that is, the left connecting piece 11 and the flexible straight part 132 form a similar “V”-shaped structure.

For the third type, the connection method is similar to that of the second type, except that it uses embedded insertion. The frames of the left lens 21 assembly 20 and the right lens assembly 30 would be provided with grooves respectively matched with the left and right connecting pieces 12 to facilitate insertion.

At the same time, for the first and second types, the shape of the left connecting piece 11 and the right connecting piece 12 may be a straight shape, and they may be directly welded to the two ends of the connecting top bar 40.

The flexible nose pad 10 in the present utility model may be applied to glasses with most structures. Specifically, the said left lens 21 assembly 20 and the right lens assembly 30 have the same structure, and both comprise the lens 21 and the temple 22. The connecting top bar 40 between the said two lenses 21 adopts the first folding structure or a conventional connecting structure; the middle part of the temple 22 adopts the second folding structure or a conventional integrated structure.

In summary, compared with the existing glasses, the glasses proposed in the present utility model have the following advantages by setting flexible nose pads between the left lens assembly and the right lens assembly:

First, the flexible nose pads may be adjusted at will according to the shape of nose bridges of different people, suitable for most people;

Second, during a process of folding, even if the folded temples are pressed against the flexible nose pads, the flexible nose pads would not deform. Moreover, when the temples are no longer pressed onto the flexible nose pads, they would be directly restored to their original shape, making the folding process smoother.

Third, when the folded glasses need to be put into a storage box, there is no need to worry about the flexible nose pads being compressed. As a result, the internal space of the storage box is reduced, making it easy to carry.

The utility model is illustratively described above with reference to the drawings. Obviously, the specific implementation of the present utility model is not limited by the above manners. Where various insubstantial improvements made with the methods, concepts and technical proposals proposed by the present utility model are employed, or the concepts and technical proposals presented in the present utility model are directly applied to other occasions without improvement, they all fall in the protection scope of the present utility model.

1. A type of glasses provided with flexible nose pads, comprising a left lens assembly and a right lens assembly arranged symmetrically and connected by a top bar, wherein the glasses also contain flexible nose pads, one end of which is arranged on the left lens assembly and the other end of which is arranged on the right lens assembly; the elastic middle part of the flexible nose pad is adapted to the shape of the nose bridge.

2. A type of glasses provided with flexible nose pads according to claim 1, wherein the flexible nose pads are integrally formed.

3. A type of glasses provided with flexible nose pads according to claim 1, wherein the flexible nose pads include a left connecting piece connected with the left lens assembly, a right connecting piece connected with the right lens assembly, and a flexible structure located between the left connecting piece and the right connecting piece.

4. A type of glasses provided with flexible nose pads according to claim 3, wherein the flexible structure includes a flexible arc part at the front end of the human nose bridge and a flexible straight part at both ends of the human nose bridge.

5. A type of glasses provided with flexible nose pads according to claim 3, wherein the left connecting piece and the right connecting piece are respectively connected to the left lens assembly and the right lens assembly.

6. A type of glasses provided with flexible nose pads according to claim 3, wherein the left connecting piece and the right connecting piece are respectively connected to both ends of the top bar.

7. A type of glasses provided with flexible nose pads according to claim 1, wherein the left lens assembly and the right lens assembly have the same structure, and both comprising lenses and temples.

8. A type of glasses provided with flexible nose pads according to claim 7, wherein the top bar between the two lenses adopts the first folding structure or a conventional connecting structure.

9. A type of glasses provided with flexible nose pads according to claim 7, wherein the middle part of the temples adopts the second folding structure or a conventional integrated structure.

10. A type of glasses provided with flexible nose pads according to claim 7, wherein both the left lens assembly and the right lens assembly further comprise frames.
